(19) United States
(12) Patent Application Publication
(10) Pub. No.: US 2019/0287206 A1
(43) Pub. Date: Sep. 19, 2019

(54) IMAGE PROCESSING APPARATUS AND IMAGE PROCESSING METHOD

(71) Applicants: Kabushiki Kaisha Toshiba, Tokyo (JP); Toshiba Electronic Devices & Storage Corporation, Tokyo (JP)

(72) Inventor: Masashi Jobashi, Taito Tokyo (JP)

(21) Appl. No.: 16/126,174

(22) Filed: Sep. 10, 2018

(30) Foreign Application Priority Data
Mar. 15, 2018 (JP) 2018-048167

(51) Int. Cl. G06T 1/20; G06F 7/58; G06T 1/60; G06F 11/27

(52) U.S. Cl. CPC G06T 1/20; G06F 11/27; G06T 1/60; G06F 7/582

(57) ABSTRACT

An image processing apparatus according to an embodiment has: a first pseudo random number generator configured to generate a pseudo random number and write the pseudo random number into a first memory; a processing circuit configured to read out the random number from the first memory, execute specific processing on the random number, and write a processing result of the specific processing into a second memory; a first signature generator configured to read out the processing result from the second memory, and generate a signature based on the processing result; and a first signature comparator configured to compare the signature generated by the first signature generator and a first expected value, the first expected value being an expected value of a signature based on the random number generated by the first pseudo random number generator and based on processing contents of the processing circuit.

### CROSS-REFERENCE TO RELATED APPLICATIONS

This application is based upon and claims the benefit of priority from Japanese Patent Application No. 2018-048167, filed on Mar. 15, 2018; the entire contents of which are incorporated herein by reference.

### FIELD

Embodiments of the present disclosure relate to an image processing apparatus and an image processing method.

### BACKGROUND

An image processing circuit for vehicle installation is required to achieve a high automotive safety integrity level (ASIL). To ensure the high safety integrity level, it may be necessary to mount a self-testing function which detects whether a failure occurs in operation. Examples of the method of detecting the failure by performing self-testing include a method of detecting by Logic BIST (Built-In Self Test), a method of detecting by duplicating a circuit, a method of detecting using test data and so on.

However, the detection method by Logic BIST has a problem of a test time for detecting the failure being long, and the method of duplicating a circuit has a problem of a circuit scale becoming larger to lead to an increase in power consumption. Therefore, the methods cannot be adopted in terms of design.

Besides, the method of detecting the failure using test data requires that an area into which the test data is stored is prepared in advance in the image processing apparatus, and has a problem of making the area of the memory tight. Besides, it is conceivable that a bus is used to transfer the test data from the memory to each processing circuit, but the transfer of the test data causes a problem of making the band width on the bus tight.

### BRIEF DESCRIPTION OF THE DRAWINGS

FIG. 1 is a block diagram for explaining the internal configuration of an image processing system according to a first embodiment;

FIG. 2 is a diagram for explaining an example of a bank configuration of a memory provided in an image processing apparatus;

FIG. 3 is a block diagram for explaining the internal configuration of an image processing system according to a second embodiment;

FIG. 4A is a diagram for explaining pipeline processing in normal image processing; and

FIG. 4B is a diagram for explaining parallel processing in self-testing processing of circuit failure.

### DETAILED DESCRIPTION

Hereinafter, an image processing apparatus and an image processing method according to embodiments will be explained referring to the drawings. Note that, in the following explanation, the same reference signs are given to components having substantially the same functions and configurations, and duplicated explanation will be made in a necessary case.

### First Embodiment

An image processing apparatus according to a first embodiment is an apparatus applied to a system required to have high reliability, for example, a system of an on-vehicle product, a medical instrument or the like. The image processing apparatus is an image processing apparatus with a memory and including a pseudo random number generator, a signature generator which converts a processing result obtained by processing a pseudo random number generated by the pseudo random number generator into a signature by a processing circuit, and a signature comparator which compares the signature generated by the signature generator and an expected value, so as to be able to detect a failure of the image processing apparatus while suppressing use of the memory and a bus. In short, the image processing apparatus according to the first embodiment constitutes an image processing apparatus with a self-testing function. Hereinafter, details thereof will be explained.

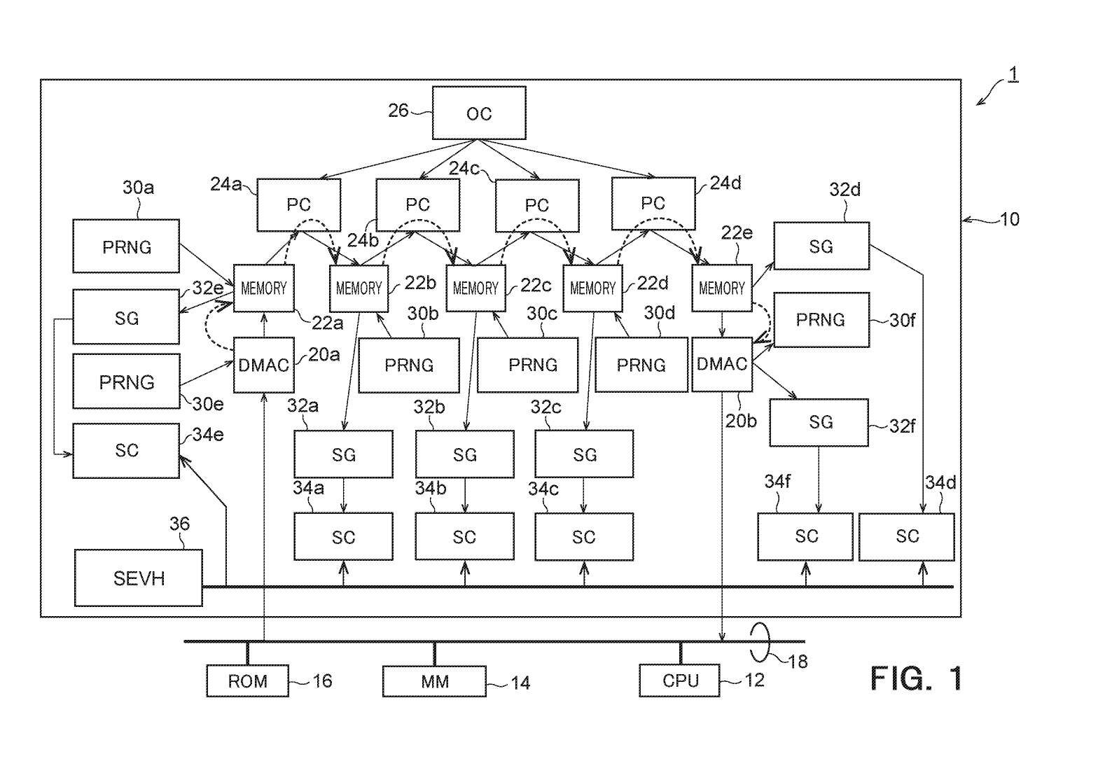

FIG. 1 is a block diagram for explaining an example of the internal configuration of an image processing system 1 including an image processing apparatus 10 according to this embodiment.

The image processing system 1 includes a CPU (Central Processing Unit) 12, a main memory 14, and a ROM (Read Only Memory) 16 in addition to the image processing apparatus 10, and the image processing apparatus 10, the CPU 12, the main memory 14, and the ROM 16 are connected with one another via a bus 18.

The CPU 12 is a control circuit which performs overall control of the image processing system 1. More specifically, the CPU 12 reads in and executes various programs stored in the ROM 16 and thereby performs various kinds of control in the image processing system 1. In execution of the programs, the CPU 12 stores calculation results and data into the main memory 14 as needed, and reads out the calculation results and data stored in the main memory 14.

The main memory 14 is composed of, for example, a RAM (Random Access Memory) and can temporarily store various kinds of data and programs. The data to be written into the main memory 14 is transferred via the bus 18 from the CPU 12 or the ROM 16, and the data read out from the main memory 14 is transferred via the bus 18 to the CPU 12 or the ROM 16.

The ROM 16 stores, in a nonvolatile manner, various programs and data necessary to perform overall control of the image processing system 1. The program or data read out from the ROM 16 is transferred via the bus 18 to the CPU 12 or the main memory 14.

The image processing apparatus 10 is a circuit which performs image processing, and is installed, particularly in this embodiment, in an automobile, and processes an image captured from the automobile. In short, the image processing system 1 according to this embodiment constitutes a system for vehicle installation.

The image processing apparatus 10 is constituted including direct memory access controllers 20a, 20b, memories 22a to 22e, processing circuits 24a to 24d, and an overall control device 26. Normal image processing performed in the image processing apparatus 10 using these circuits will be explained first.

The direct memory access controllers 20a, 20b are controllers which control the transfer of the data via the bus 18. More specifically, the direct memory access controller 20a is a controller which controls the transfer of data between the bus 18 and the memory 22a, and the direct memory access controller 20b is a controller which controls the transfer of data between the memory 22e and the bus 18.

The memories 22a to 22e are internal memories provided inside the image processing apparatus 10. These memories 22a to 22e are composed of, for example, a RAM (Random Access Memory). The memories 22a to 22e have a relatively large memory area in terms of performing image processing, and data in each process for performing image processing by pipeline processing is stored in each of the memories 22a to 22e.

Each of the processing circuits 24a to 24d is a circuit which executes specific processing on acquires data. More specifically, the processing circuit 24a reads out data from the memory 22a, executes specific processing on the data, and writes a processing result of the specific processing into the memory 22b. Similarly, the processing circuit 24b reads out the data written by the processing circuit 24a from the memory 22b, executes specific processing on the data, and writes a processing result of the specific processing into the memory 22c. The processing circuits 24c, 24d also execute the same processing. Therefore, a final processing result by the processing circuits 24a to 24d is to be written into the memory 22e.

In this embodiment, for example, the processing circuit 24a reads out the image data (RAW data) written into the memory 22a, performs demosaic processing on the image data, and writes a result of the demosaic processing into the memory 22b. The processing circuit 24b reads out the data subjected to the demosaic processing from the memory 22b, performs noise cut processing on the data, and writes a result of the noise cut processing into the memory 22c. The processing circuit 24c reads out the data subjected to the noise cut processing from the memory 22c, performs gamma correction processing on the data, and writes a result of the gamma correction processing into the memory 22d. The processing circuit 24d reads out the data subjected to the gamma correction processing from the memory 22d, performs YUV conversion processing on the data, and writes a result of the YUV conversion processing into the memory 22e. Each of the processing circuits 24a to 24d has a specific processing function as described above, and performs specific processing on the data read in from the memory at the preceding stage and performs writing of a result of the specific processing into the memory at the subsequent stage. Pipeline-controlling the above processing enables the data written into the memory 22a to be sequentially processed and sequentially written into the memory 22e as a final processing result.

The overall control device 26 is a circuit which performs overall control necessary to pipeline-control the processing. In other words, the overall control device 26 controls each of the processing circuits 24a to 24d and the direct memory access controllers 20a, 20b so that the image processing is executed by the pipeline processing.

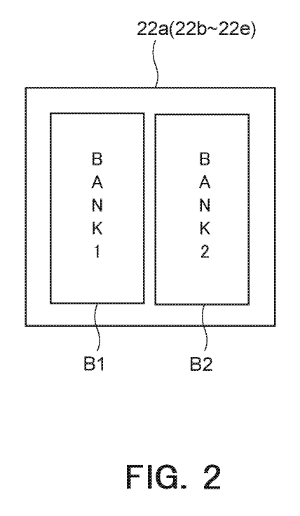

To realize the above-explained pipeline control, the memories 22a to 22e include a plurality of banks. FIG. 2 is a conceptual diagram for explaining an example of a bank configuration of the memory 22a. Note that the memories 22b to 22e according to this embodiment also have the same bank configuration as that of the memory 22a.

As illustrated in FIG. 2, the memory 22a includes two banks B1, B2 as areas into which the direct memory access controller 20a stores data. The direct memory access controller 20a stores the data acquired via the bus 18, for example, first into the bank B1. Then, when storage of one block or one frame or the like into the bank B1 is completed, the direct memory access controller 20a stores the next block or the next frame or the like into the bank B2 being the other bank. While the data is being stored into the bank B2, the processing circuit 24a reads out the data stored in the bank B1, executes the specific processing on the data, and stores a processing result into, for example, the bank B1 in the memory 22b.

Since the storage of the data into the bank B2 of the memory 22a is completed by the time when the processing circuit 24a completes the processing of the data stored in the bank B1 of the memory 22a, the processing circuit 24a, after completing the processing for the bank B1 of the memory 22a, reads out the data from the bank B2 and starts processing of the data of the next block or the next frame or the like. The processing circuit 24a then stores a processing result of the data into the bank B2 of the memory 22b. Since the processing for the bank B1 of the memory 22a has been completed, the direct memory access controller 20a writes the data acquired via the bus 18 again into the bank B1 of the memory 22a.

As described above, in each of the memories 22a to 22e, the two banks B1, B2 are formed, and alternate use of the two banks B1, B2 avoids as much as possible generation of waiting time in the processing circuits 24a to 24d. Note that though the example where each of the memories 22a to 22e includes the two banks B1, B2 is explained in FIG. 2, the number of banks is not limited to two, but only needs to be plural such as three of four.

The explanation of the normal image processing in the image processing apparatus 10 is as in the above, and self-testing processing of circuit failure in the image processing apparatus 10 will be explained next. To perform the self-testing processing of circuit failure, the image processing apparatus 10 according to this embodiment includes pseudo random number generators 30a to 30f, signature generators 32a to 32f, signature comparators 34a to 34f, and a signature expected value holder 36 in addition to the above. The self-testing processing of circuit failure is executed, for example, directly after the image processing apparatus 10 starts by supply of power. Besides, not limited to that, the data on an image is supplied to the memory 22a, for example, on a 30-frames-per-second basis, and the self-testing processing of circuit failure is also executed between the frames.

In the self-testing processing of circuit failure, the pseudo random number generator 30a generates a pseudo random number and writes the pseudo random number into the memory 22a. The pseudo random number here means not being a true random number. More specifically, when given one seed, the pseudo random number generator 30a generates a random number according to a predetermined regularity, so that if the seed is determined, a random number to be generated can be specified in advance. In other words, the same seed as the seed given to the pseudo random number generator 30a is given to another pseudo random number generator having the same structure, the same random number is generated also in the other pseudo random number generator. Therefore, a random number generator having the predetermined regularity and capable of specifying in advance the random number to be generated for one seed can be said to be a pseudo random number generator which generates a pseudo random number in this embodiment regardless of the size of the circuit scale.

Note that the configurations of the pseudo random number generators 30b to 30f are the same as that of the pseudo random number generator 30a. More specifically, the pseudo random number generator 30b generates a pseudo random number and writes the pseudo random number into the memory 22b, the pseudo random number generator 30c generates a pseudo random number and writes the pseudo random number into the memory 22c, and the pseudo random number generator 30d generates a pseudo random number and writes the pseudo random number into the memory 22d. The pseudo random number generator 30e generates a pseudo random number and supplies the pseudo random number to the direct memory access controller 20a as if the pseudo random number is the data acquired from the bus 18, and the pseudo random number generator 30f generates a pseudo random number and supplies the pseudo random number to the direct memory access controller 20b as if the pseudo random number is the data acquired from the memory 22e.

Each of the pseudo random number generators 30a to 30f generates, as the pseudo random number, test data suitable to perform a diagnosis for failure of the processing circuits 24a to 24d and the direct memory access controllers 20a, 20b. The test data suitable for the failure diagnosis here means data which is in conformity to the size of data to be processed by each of the processing circuits 24a to 24d and the direct memory access controllers 20a, 20b and from which failure of circuits can be easily found.

As described above, in this embodiment, the memories 22a to 22d have the two banks B1, B2, and therefore the pseudo random number generators 30a to 30d also write the random number alternately into the two banks B1, B2.

The processing circuit 24a reads out the random number alternately from the two banks B1, B2 of the memory 22a, executes the specific processing on the random number, and writes a result of the execution alternately into the two banks B1, B2 of the memory 22b. More specifically, assuming that the bank into which the direct memory access controller 20a is writing the data into the memory 22a is the bank B1, the pseudo random number generator 30a writes the random number into the bank B2 of the memory 22a, and the processing circuit 24a reads in the random number as data from the bank B2 of the memory 22a. The processing circuit 24a then performs the specific processing specified in advance on the read data, and writes a result of the processing into, for example, the bank B1 of the memory 22b. In this case, the pseudo random number generator 30b writes the generated random number as data into the bank B2 of the memory 22b, and the processing circuit 24b reads in the random number as data from the bank B2 of the memory 22b.

The operations of the processing circuits 24b to 24d are the same, and the processing circuit 24b reads out the random number from one of the banks of the memory 22b, executes the specific processing on the random number, and writes a result of the specific processing into one of the banks of the memory 22c. The processing circuit 24c reads out the random number from the other of the banks of the memory 22c, executes the specific processing on the random number, and writes a result of the specific processing into one of the banks of the memory 22d. The processing circuit 24d reads out the random number from the other of the banks of the memory 22d, executes the specific processing on the random number, and writes a result of the specific processing into one of the banks of the memory 22e.

The signature generator 32a reads out the processing result alternately from the banks B1, B2 of the memory 22b, and generates a signature based on the processing result. There are various methods for generating a signature here which are used, for example, in the CRC (Cyclic Redundancy Check) technology for detecting data error or used in the data encryption technology. In this embodiment, the method is used as the technology of generating a shorter representative value by converting large data being the processing result stored in the memory 22b into a signature. In other words, when original data to be converted into a signature is different, a different signature is generated. In this embodiment, this characteristic is utilized to inspect whether the data written in the memory 22a is data which has been appropriately processed with no failure occurring in the memory 22a, the processing circuit 24a, and the memory 22b.

This also applies to the signature generators 32b to 32d. More specifically, the signature generator 32b reads out the processing result by the processing circuit 24b written in the memory 22c, and generates a signature based on the processing result. The signature generator 32c reads out the processing result by the processing circuit 24c written in the memory 22d, and generates a signature based on the processing result. The signature generator 32d reads the processing result by the processing circuit 24d written in the memory 22e, and generates a signature based on the processing result.

The signature comparator 34a compares the signature generated by the signature generator 32a and an expected value of a signature based on the random number generated by the pseudo random number generator 30a and on the processing contents of the processing circuit 24a. The random number generated by the pseudo random number generator 30a has the predetermined regularity here as described above, so that when, for example, the seed is fixed or a predetermined regularity is determined also in the seed, the pseudo random number generated by the pseudo random number generator 30a can also be specified in advance. Since the processing executed by the processing circuit 24a is also determined in advance, the processing result written into the memory 22b can also be specified in advance, and the signature generated from the processing result can also be specified in advance. Therefore, the signature comparator 34a regards the signature based on the processing result which can be specified in advance as the expected value, and compares the signature generated by the signature generator 32a with the expected value.

This also applies to the signature comparators 34b to 34d. More specifically, the signature comparator 34b compares the signature generated by the signature generator 32b and an expected value of a signature based on the random number generated by the pseudo random number generator 30b and on the processing contents of the processing circuit 24b. The signature comparator 34c compares the signature generated by the signature generator 32c and an expected value of a signature based on the random number generated by the pseudo random number generator 30c and on the processing contents of the processing circuit 24c. The signature comparator 34d compares the signature generated by the signature generator 32d and an expected value of a signature based on the random number generated by the pseudo random number generator 30d and on the processing contents of the processing circuit 24d.

In this embodiment, the signatures as the expected values used in the signature comparators 34a to 34d are stored in advance in the signature expected value holder 36. More specifically, the pseudo random numbers generated by the pseudo random number generators 30a to 30d can be specified in advance at the stage of designing the image processing apparatus 10, and the processing contents of the processing circuits 24a to 24d are also determined in advance. Therefore, the signatures as the expected values corresponding to the pseudo random numbers generated by the pseudo random number generators 30a to 30d can be stored in the signature expected value holder 36 at the stage of designing the image processing apparatus 10. The signature comparators 34a to 34d read out the signatures as the expected values stored in the signature expected value holder 36, and compare them with the signatures generated by the signature generators 32a to 32d.

In the self-testing processing of circuit failure, the pseudo random number generator 30e generates a pseudo random number and supplies the pseudo random number to the direct memory access controller 20a. The direct memory access controller 20a writes the random number generated by the pseudo random number generator 30e into the memory 22a as if the pseudo random number is the data acquired from the bus 18. In other words, the pseudo random number generator 30e writes the data alternately into the two banks B1, B2 of the memory 22a in a manner not to overlap with writing of the random number by the pseudo random number generator 30a.

The signature generator 32e reads out the data written by the direct memory access controller 20a from the memory 22a, and generates a signature based on the read out data. More specifically, the signature generator 32e reads out the data alternately from the two banks B1, B2 of the memory 22a. The signature comparator 34e compares the signature generated by the signature generator 32e and the expected value of the signature based on the random number generated by the pseudo random number generator 30e. More specifically, if the direct memory access controller 20a and the memory 22a normally operate, the signature generated by the signature generator 32e and the expected value of the signature based on the random number generated by the pseudo random number generator 30e are supposed to coincide with each other. Therefore, the signature comparator 34e compares them to diagnose whether or not the direct memory access controller 20a or the memory 22a fails.

On the other hand, the pseudo random number generator 30f generates a pseudo random number and supplies the pseudo random number to the direct memory access controller 20b. The direct memory access controller 20b supplies the random number generated by the pseudo random number generator 30f to the signature generator 32f as if the pseudo random number is the data read out from the memory 22e. The signature generator 32f generates a signature based on the data acquired from the direct memory access controller 20b and supplies the signature to the signature comparator 34f. The signature comparator 34f compares the signature generated by the signature generator 32f and the expected value of the signature based on the random number generated by the pseudo random number generator 30f. More specifically, if the direct memory access controller 20b normally operates, the signature generated by the signature generator 32f and the expected value of the signature based on the random number generated by the pseudo random number generator 30f are supposed to coincide with each other. Therefore, the signature comparator 34f compares them to diagnose whether or not the direct memory access controller 20b fails.

In this embodiment, the signatures as the expected values used in the signature comparators 34e, 34f are also stored in advance in the signature expected value holder 36. More specifically, the pseudo random numbers generated by the pseudo random number generators 30e, 30f can be specified in advance at the stage of designing the image processing apparatus 10, and the direct memory access controllers 20a, 20b are controllers which basically control the transfer of the data, so that the generated random numbers are supplied as they are as data to the signature generators 32e, 32f. Therefore, the signatures as the expected values corresponding to the pseudo random numbers generated by the pseudo random number generators 30e, 30f can be stored in the signature expected value holder 36 at the stage of designing the image processing apparatus 10. The signature comparators 34e, 34f read out the signatures as the expected values stored in the signature expected value holder 36, and compare them with the signatures generated by the signature generators 32e, 32f.

Note that the above-described self-testing processing of circuit failure may be controlled by the overall control device 26, may be controlled by the CPU 12, or may be controlled by the overall control device 26 and the CPU 12 in cooperation. Further, switching control between the normal image processing and the self-testing processing of circuit failure may be controlled by the overall control device 26, may be controlled by the CPU 12, or may be controlled by the overall control device 26 and the CPU 12 in cooperation.

As is found from the above, in this embodiment, the pseudo random number generator 30a, the processing circuit 24a, the signature generator 32a, and the signature comparator 34a constitute a first unit being one unit, the pseudo random number generator 30b, the processing circuit 24b, the signature generator 32b, and the signature comparator 34b constitute a second unit being one unit, the pseudo random number generator 30c, the processing circuit 24c, the signature generator 32c, and the signature comparator 34c constitute a third unit being one unit, and the pseudo random number generator 30d, the processing circuit 24d, the signature generator 32d, and the signature comparator 34d constitute a fourth unit being one unit.

Further, the pseudo random number generator 30e, the direct memory access controller 20a, the signature generator 32e, and the signature comparator 34e constitute a fifth unit being one unit, and the pseudo random number generator 30f, the direct memory access controller 20b, the signature generator 32f, and the signature comparator 34f constitute a sixth unit being one unit.

The memory 22a is used in common by the first unit and the fifth unit, the memory 22b is used in common by the first unit and the second unit, the memory 22c is used in common by the second unit and the third unit, the memory 22d is used in common by the third unit and the fourth unit, and the memory 22e is used in common by the fourth unit and the sixth unit.

Further, for example, in the first unit in this embodiment, the pseudo random number generator 30a constitutes a first pseudo random number generator, the signature generator 32a constitutes a first signature generator, and the signature comparator 34a constitutes a first signature comparator. In this case, the memory 22a constitutes a first memory, and the memory 22b constitutes a second memory. These points apply not only to the first unit but also to the second unit, the third unit, and the fourth unit.

Further, in the fifth unit, the pseudo random number generator 30e constitutes a second pseudo random number generator, the direct memory access controller 20a constitutes a first controller, the signature generator 32e constitutes a second signature generator, and the signature comparator 34e constitutes a second signature comparator. In this case, the memory 22a constitutes the first memory.

Further, in the sixth unit, the pseudo random number generator 30f constitutes a third pseudo random number generator, the direct memory access controller 20b constitutes a second controller, the signature generator 32f constitutes a third signature generator, and the signature comparator 34f constitutes a third signature comparator.

It can be said that the first unit to the fourth unit are connected in series to constitute the image processing apparatus 10. In this case, it can be said that the fifth unit is connected to an input side of the first unit and the sixth unit is connected to an output side of the fourth unit. Further, the overall control device 26 in this embodiment constitutes a first control device.

Note that in this embodiment, when one of the signature comparators 34a to 34f determines that the signature acquired from the signature generator 32a to 32f does not coincide with the expected value, it can be diagnosed that a failure occurs in one of the circuits of the unit. When the signature comparator 34a of the first unit determines that the signature acquired from the signature generator 32a does not coincide with the expected value of the signature acquired from the signature expected value holder 36, it can be diagnosed that a failure occurs in one of the memories 22a, 22b and the processing circuit 24a. This diagnostic result is reported, for example, to the CPU 12, and shutdown or the like of the image processing apparatus 10 or the image processing system 1 can be performed under control of the CPU 12.

As described above, the image processing system 1 according to this embodiment eliminates the necessity to transfer the test data via the bus 18 to the image processing apparatus 10 at the time when the self-testing processing of circuit failure is executed in the image processing apparatus 10. Therefore, the problem of tightness of the band width of the bus 18 can be avoided by using self-detection processing of circuit failure. Further, it is unnecessary to prepare, in the image processing apparatus 10, a memory area for storing the test data, thus making it possible to suppress the consumption of the memory of the image processing apparatus 10.

Specifically, the test data necessary for the self-testing processing of circuit failure is generated as the pseudo random numbers by the pseudo random number generators 30a to 30f and the pseudo random numbers are made to have the predetermined regularity, thus making it possible to specify the pseudo random numbers generated by the pseudo random number generators 30a to 30f in advance at the stage of designing the image processing system 1. Therefore, the signature comparators 34a to 34f can specify in advance the expected values to be compared with the signatures generated by the signature generators 32a to 32f, and the expected values can be stored in advance in the signature expected value holder 36.

Further, since there is substantially no transfer of the test data using the bus 18, the processing time for the self-testing processing of circuit failure can be shortened. Therefore, it is possible to insert the execution of the self-testing processing of circuit failure into every portion of the image processing, and improve the failure detection rate of the image processing apparatus 10. In other words, increasing the number of times of executing the self-testing processing of circuit failure enables more accurate circuit failure diagnosis. Further, it is possible to reduce the circuit scale as compared with the case of duplicating a circuit as in the prior art, and suppress power consumption.

### Second Embodiment

An image processing apparatus in an image processing system according to a second embodiment is made to shorten the processing time of failure diagnosis by additionally providing, in the image processing apparatus 10 in the above-described first embodiment, a test-time overall control device which stops the pipeline processing and causes all of processing circuits to execute processing in parallel in the self-testing processing of circuit failure, Hereinafter, portions different from the above-described first embodiment will be explained.

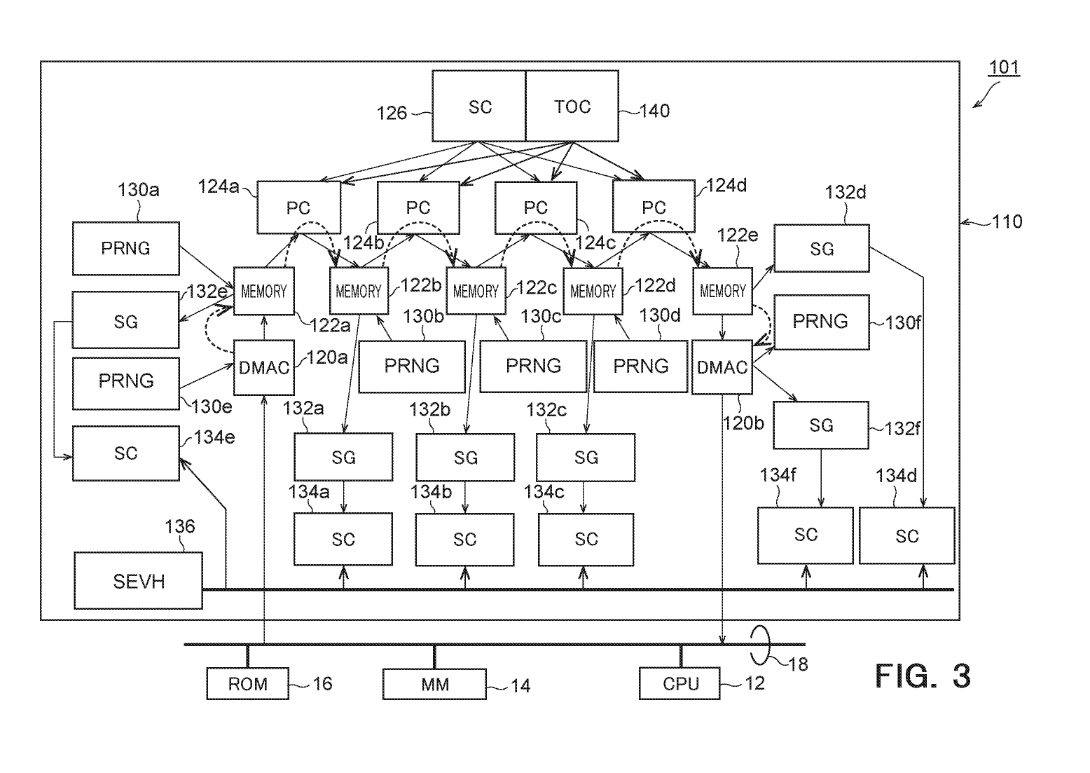

FIG. 3 is a block diagram for explaining an example of the internal configuration of an image processing system 101 according to this embodiment. An image processing apparatus 110 of the image processing system 101 according to this embodiment is constituted by additionally providing a test-time overall control device 140 in the image processing apparatus 10 in the above-described first embodiment.

Normal image processing in the image processing apparatus 110 in FIG. 3 is the same as that in the above-described first embodiment. However, the operation in executing the self-testing processing of circuit failure is different from that in the above-described first embodiment. More specifically, in the image processing apparatus 110 according to this embodiment, an overall control device 126 performs data processing by pipeline control for the normal image processing, whereas a test-time overall control device 140 stops the pipeline control and performs parallel processing for the self-testing processing of circuit failure. In order to realize the above, in the image processing apparatus 110 according to this embodiment, the test-time overall control device 140 which performs control regarding the parallel processing in the self-testing processing of circuit failure is provided in addition to the overall control device 126 which performs control regarding the pipeline processing in the normal image processing. The test-time overall control device 140 constitutes a second control device in this embodiment.

Note that, in terms of functions, direct memory access controllers 120a, 120b according to this embodiment correspond to the direct memory access controllers 20a, 20b according to the first embodiment, memories 122a to 122e according to this embodiment correspond to the memories 22a to 22e according to the first embodiment, processing circuits 124a to 124d according to this embodiment correspond to the processing circuits 24a to 24d according to the first embodiment, the overall control device 126 according to this embodiment corresponds to the overall control device 26 according to the first embodiment, pseudo random number generators 130a to 130f according to this embodiment correspond to the pseudo random number generators 30a to 30f according to the first embodiment, signature generators 132a to 132f according to this embodiment correspond to the signature generators 32a to 32f according to the first embodiment, signature comparators 134a to 134f according to this embodiment correspond to the signature comparators 34a to 34f according to the first embodiment, and a signature expected value holder 136 according to this embodiment corresponds to the signature expected value holder 36 according to the first embodiment, but their internal configurations are different, and therefore different codes are given to them.

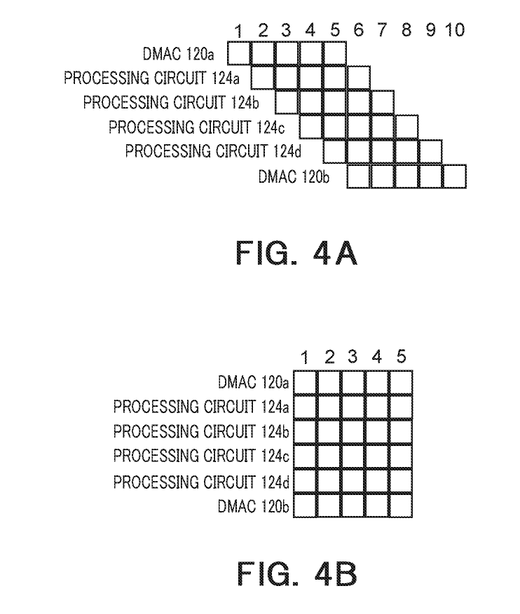

FIG. 4A and FIG. 4B are diagrams for explaining the concepts of the pipeline processing and the parallel processing executed in the image processing apparatus 110 in this embodiment, FIG. 4A illustrates the pipeline processing in the normal image processing, and FIG. 4B illustrates the parallel processing in the self-testing processing of circuit failure.

As is found from FIG. 4A, in the pipeline processing in the normal image processing to be performed in the overall control device 126, processing proceeds as follows.

### <Time Slot 1>

The direct memory access controller 120a acquires data from the bus 18 and writes the data into the memory 122a.

### <Time Slot 2>

The processing circuit 124a acquires the data written in Time slot 1 from the memory 122a, performs specific processing on the data, and writes a result of the specific processing into the memory 122b.

### <Time Slot 3>

The processing circuit 124b acquires the data written in Time slot 2 from the memory 122b, performs specific processing on the data and writes a result of the specific processing into the memory 122c.

### <Time Slot 4>

The processing circuit 124c acquires the data written in Time slot 3 from the memory 122c, performs specific processing on the data, and writes a result of the specific processing into the memory 122d.

### <Time Slot 5>

The processing circuit 124d acquires the data written in Time slot 4 from the memory 122d, performs specific processing on the data, and writes a result of the specific processing into the memory 122e.

### <Time Slot 6>

The direct memory access controller 120b acquires the data written in Time slot 5 from the memory 122e, and transfers the data via the bus 18.

Processing of the second image data and processing of the third processing image data and so on subsequent to the processing of the first image data are sequentially performed in a pipeline manner in time slots subsequent to the processing of the first image data.

In the image processing apparatus 110 in the above-described first embodiment, the pipeline processing is similarly performed also in the self-testing processing of circuit failure, and the processing proceeds as follows.

### <Time Slot 1>

The pseudo random number generator 130e generates a pseudo random number and writes the pseudo random number into the memory 122a, and a diagnosis by the signature generator 132e and the signature comparator 134e is performed.

### <Time Slot 2>

The pseudo random number generator 130a generates a pseudo random number and writes the pseudo random number into the memory 122a, and the processing circuit 124a acquires the pseudo random number as data from the memory 122a, performs specific processing on the data, and writes a result of the specific processing into the memory 122b, and a diagnosis by the signature generator 132a and the signature comparator 134a is performed.

### <Time Slot 3>

The pseudo random number generator 130b generates a pseudo random number and writes the pseudo random number into the memory 122b, and the processing circuit 124b acquires the pseudo random number as data from the memory 122b, performs specific processing on the data, and writes a result of the specific processing into the memory 122c, and a diagnosis by the signature generator 132b and the signature comparator 134b is performed.

### <Time Slot 4>

The pseudo random number generator 130c generates a pseudo random number and writes the pseudo random number into the memory 122c, and the processing circuit 124c acquires the pseudo random number as data from the memory 122c, performs specific processing on the data, and writes a result of the specific processing into the memory 122d, and a diagnosis by the signature generator 132c and the signature comparator 134c is performed.

### <Time Slot 5>

The pseudo random number generator 130d generates a pseudo random number and writes the pseudo random number into the memory 122d, and the processing circuit 124d acquires the pseudo random number as data from the memory 122d, performs specific processing on the data, and writes a result of the specific processing into the memory 122e, and a diagnosis by the signature generator 132d and the signature comparator 134d is performed.

<Time Slot 6>

The pseudo random number generator 130f generates a pseudo random number and supplies the pseudo random number to the direct memory access controller 120b, and a diagnosis by the signature generator 132f and the signature comparator 134f is performed.

The second diagnostic processing, the third diagnostic processing and so on subsequent to the first diagnostic processing are sequentially performed in a pipeline manner in time slots subsequent to the first diagnostic processing.

As illustrated in FIG. 4A, when the diagnostic processing for the circuit is performed five times, 10 time slots in total are required to complete all of the diagnoses. Hence, in the self-testing processing of circuit failure, the image processing apparatus 110 according to this embodiment stops the pipeline processing and performs the parallel processing as illustrated in FIG. 4B to shorten the processing time.

More specifically, as illustrated in FIG. 4B, the test-time overall control device 140 controls individually in parallel the direct memory access controllers 120a, 120b and the processing circuits 124a to 124d so as to perform parallel processing. In other words, the above processing in <Time slot 1> to the above processing in <Time slot 6> are simultaneously performed in Time slot 1. Therefore, when the diagnosis for circuit failure is performed five times, only five time slots in total are required to complete all of the diagnoses. Therefore, the time required for the self-testing processing of circuit failure can be significantly shortened.

As described above, also in the image processing apparatus 110 of the image processing system 101 according to this embodiment, it is possible to perform accurate circuit failure diagnosis while avoiding the transfer of the test data making the band width of the bus 18 tight and the test data consuming the memory in the image processing apparatus 110 at the time when the self-testing processing of circuit failure is executed, as in the above-described first embodiment.

Further, according to the image processing system 101 according to this embodiment, the test-time overall control device 140 which controls the image processing apparatus 110 to stop the pipeline processing and perform the parallel processing at the time when the self-testing processing of circuit failure is performed in the image processing apparatus 110 is additionally provided, thus making it possible to shorten the time required for the diagnosis for circuit failure. For example, when the diagnostic processing for the circuit is performed five times as illustrated in FIG. 4A and FIG. 4B, the time required for the processing can be cut in half as compared with that in the image processing apparatus 10 in FIG. 1.

Therefore, for example, the number of times of diagnostic processing for the circuit executable per unit time can be increased to improve the reliability of the circuit diagnosis. Note that it is conceivable that even if the diagnostic processing for the circuit is executed in parallel, the increase in allover power consumption is not so large because the processing time has been shortened.

Note that the signature expected value holders 36, 136 in the above-described first embodiment and second embodiment do not always have to be provided in the image processing apparatuses 10, 110, but expected values may be read in from the external parts of the image processing apparatuses 10, 110 and used. For example, in the embodiments, the signature as the expected value is stored in the ROM 16, and the image processing apparatuses 10, 110 may acquire it via the bus 18. For example, each of the signature comparators 34a to 34f, 134a to 134f of the image processing apparatuses 10, 110 may acquire the signature as the expected value from the ROM 16. Also in this case, it is conceivable that the data size of the signature as the expected value is not so large and therefore does not make the band width of the bus 18 tight as in the prior art.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image processing apparatus comprising:
a first pseudo random number generator configured to generate a pseudo random number and write the pseudo random number into a first memory;
a processing circuit configured to read out the random number from the first memory, execute specific processing on the random number, and write a processing result of the specific processing into a second memory;
a first signature generator configured to read out the processing result from the second memory, and generate a signature based on the processing result; and
a first signature comparator configured to compare the signature generated by the first signature generator and a first expected value, the first expected value being an expected value of a signature based on the random number generated by the first pseudo random number generator and based on processing contents of the processing circuit.

2. The image processing apparatus according to claim 1, further comprising:
a signature expected value holder configured to hold the first expected value, wherein
the first signature comparator acquires the first expected value from the signature expected value holder.

3. The image processing apparatus according to claim 2, wherein:
the pseudo random number generated by the first pseudo random number generator has a predetermined regularity; and
the first expected value is generated in advance based on the pseudo random number having the predetermined regularity and based on the processing contents of the processing circuit, and held in the signature expected value holder.

4. The image processing apparatus according to claim 1, further comprising:
a second pseudo random number generator configured to generate a pseudo random number;
a first controller configured to control writing of data from a bus into the first memory, and to control writing of the random number generated by the second pseudo random number generator as data into the first memory;
a second signature generator configured to read out the data from the first memory, and generate a signature based on the data; and
a second signature comparator configured to compare the signature generated by the second signature generator and a second expected value, the second expected value being an expected value of a signature based on the random number generated by the second pseudo random number generator.

5. The image processing apparatus according to claim 4, further comprising:
a signature expected value holder configured to hold the first expected value and the second expected value, wherein
the first signature comparator acquires the first expected value from the signature expected value holder, and the second signature comparator acquires the second expected value from the signature expected value holder.

6. The image processing apparatus according to claim 5, wherein:
the pseudo random numbers generated by the first pseudo random number generator and by the second pseudo random number generator have a predetermined regularity; and
the first expected value and the second expected value are generated in advance based on the pseudo random numbers having the predetermined regularity and based on the processing contents of the processing circuit, and held in the signature expected value holder.

7. The image processing apparatus according to claim 1, further comprising:
a second controller configured to control reading out of data from the second memory to a bus;
a third pseudo random number generator configured to generate a pseudo random number, and supply the pseudo random number as data to the second controller;
a third signature generator configured to acquire the random number generated by the third pseudo random number generator as data from the second controller, and generate a signature based on the data; and
a third signature comparator configured to compare the signature generated by the third signature generator and a third expected value, the third expected value being an expected value of a signature based on the random number generated by the third pseudo random number generator.

8. The image processing apparatus according to claim 7, further comprising:
a signature expected value holder configured to hold the first expected value and the third expected value, wherein
the first signature comparator acquires the first expected value from the signature expected value holder, and the third signature comparator acquires the third expected value from the signature expected value holder.

9. The image processing apparatus according to claim 8, wherein:
the pseudo random numbers generated by the first pseudo random number generator and by the third pseudo random number generator have a predetermined regularity; and
the first expected value and the third expected value are generated in advance based on the pseudo random numbers having the predetermined regularity and based on the processing contents of the processing circuit, and held in the signature expected value holder.

10. The image processing apparatus according to claim 1, wherein:
the first pseudo random number generator, the processing circuit, the first signature generator, and the first signature comparator constitute one unit; and
a plurality of the units are provided connected in series.

11. The image processing apparatus according to claim 10, further comprising a first control device configured to pipeline-control the first pseudo random number generator, the processing circuit, the first signature generator, and the first signature comparator provided in each of the plurality of units.

12. The image processing apparatus according to claim 10, further comprising a second control device configured to control individually in parallel the first pseudo random number generator, the processing circuit, the first signature generator, and the first signature comparator provided in each of the plurality of units.

13. An image processing method comprising:
a first pseudo random number generator generating a pseudo random number and writing the pseudo random number into a first memory;
a processing circuit reading out the random number from the first memory, executing specific processing on the random number, and writing a processing result of the specific processing into a second memory;
a first signature generator reading out the processing result from the second memory, and generating a signature based on the processing result; and
a first signature comparator comparing the signature generated by the first signature generator and a first expected value, the first expected value being an expected value of a signature based on the random number generated by the first pseudo random number generator and based on processing contents of the processing circuit.

14. The image processing method according to claim 13, further comprising:
a second pseudo random number generator generating a pseudo random number;
a first controller controlling writing of data from a bus into the first memory, and writing the random number generated by the second pseudo random number generator as data into the first memory;
a second signature generator reading out the data from the first memory, and generating a signature based on the data; and
a second signature comparator comparing the signature generated by the second signature generator and a second expected value, the second expected value being an expected value of a signature based on the random number generated by the second pseudo random number generator.

15. The image processing method according to claim 13, further comprising:
a second controller reading out data from the second memory to a bus;
a third pseudo random number generator generating a pseudo random number, and supplying the pseudo random number as data to the second controller;
a third signature generator acquiring the random number generated by the third pseudo random number generator as data from the second controller, and generating a signature based on the data; and
a third signature comparator comparing the signature generated by the third signature generator and a third expected value, the third expected value being an expected value of a signature based on the random number generated by the third pseudo random number generator.

16. The image processing method according to claim 13, wherein:
the first pseudo random number generator, the processing circuit, the first signature generator, and the first signature comparator constitute one unit; and
a plurality of the units are provided connected in series.

17. The image processing method according to claim 16, further comprising:
a first control device pipeline-controlling the first pseudo random number generator, the processing circuit, the first signature generator, and the first signature comparator provided in each of the plurality of units.

18. The image processing method according to claim 16, further comprising:
a second control device controlling individually in parallel the first pseudo random number generator, the processing circuit, the first signature generator, and the first signature comparator provided in each of the plurality of units.
